(19) United States
(12) Patent Application Publication
(10) Pub. No.: US 2016/0104005 A1
(43) Pub. Date: Apr. 14, 2016

(54) FACILITATING TENANT-BASED CUSTOMIZATION OF ACCESS AND SECURITY CONTROLS IN AN ON-DEMAND SERVICES ENVIRONMENT

(71) Applicant: salesforce.com, inc., San Francisco, CA (US)

(72) Inventors: ALEX TOUSSAINT, SAN FRANCISCO, CA (US); DANIEL C. SILVER, LOS ALTOS, CA (US); FRED IM, SAN CARLOS, CA (US); IGOR UKRAINCZYK, MOUNTAIN VIEW, CA (US); SANTHOSH KUMAR KUCHOOR, SAN FRANCISCO, CA (US); ALEKSANDR ASHPIS, SAN FRANCISCO, CA (US); TIM CHRISTIAN SCHMIDT, EAST PALO ALTO, CA (US)

(73) Assignee: salesforce.com, inc., San Francisco, CA (US)

(21) Appl. No.: 14/688,573

(22) Filed: Apr. 16, 2015

Related U.S. Application Data
(60) Provisional application No. 62/062,693, filed on Oct. 10, 2014.

(51) Int. Cl. G06F 21/62; G06F 17/30

(52) U.S. Cl. CPC G06F 21/6218; G06F 17/30477

(57) ABSTRACT

In accordance with embodiments, there are provided mechanisms and methods for facilitating tenant-based customization of access and security controls in an on-demand services environment in a multi-tenant environment according to one embodiment. In one embodiment and by way of example, a method includes generating, by the database system, a plurality of nodes corresponding to a plurality of tenants in a multi-tenant environment, where a node corresponding to a tenant includes data relating to the tenant. The method may further include accepting, by the database system, a plurality of security models associated with the plurality of tenants, and configuring, based on the plurality of security models, security privileges including user privileges to be assigned to the plurality of users representing the plurality of tenants.

### CLAIM OF PRIORITY

This application claims the benefit of and priority to U.S. Provisional Patent Application No. 62/062,693, entitled “FACILITATING EDGE SECURITY FORCE IN AN ON-DEMAND SERVICES ENVIRONMENT” by Alex Toussaint, et al., filed Oct. 10, 2014, Attorney Docket No.: 8956P231Z, and the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

One or more implementations relate generally to data management and, more specifically, to facilitating tenant-based customization of access and security controls in an on-demand services environment.

### BACKGROUND

Conventional techniques provide for employing a centralized instance which limits the tenants to use and exercise only the access and security controls offered by the centralized instance.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. The secure and efficient retrieval of accurate information and subsequent delivery of this information to the user system has been and continues to be a goal of administrators of database systems. Unfortunately, conventional database approaches are associated with various limitations.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates a system having a computing device employing a dynamic access and security control mechanism according to one embodiment;

FIG. 2 illustrates a dynamic access and security control mechanism according to one embodiment;

FIG. 3A illustrates an architectural setup as facilitated and supported by a dynamic access and control mechanism according to one embodiment;

FIG. 3B illustrates another architectural setup as facilitated and supported by a dynamic access and control mechanism according to one embodiment;

FIG. 4A illustrates a method for facilitating tenant-based dynamic access and security controls according to one embodiment;

FIG. 4B illustrates a transaction sequence representing a query path according to one embodiment;

FIG. 4C illustrates a transaction sequence representing a communication between a core and a dedicated node according to one embodiment;

FIG. 5 illustrates a computer system according to one embodiment;

FIG. 6 illustrates an environment wherein an on-demand database service might be used according to one embodiment; and

FIG. 7 illustrates elements of environment of FIG. 6 and various possible interconnections between these elements according to one embodiment.

### SUMMARY

In accordance with embodiments, there are provided mechanisms and methods for facilitating tenant-based customization of access and security controls in an on-demand services environment in a multi-tenant environment according to one embodiment. In one embodiment and by way of example, a method includes generating, by the database system, a plurality of nodes corresponding to a plurality of tenants in a multi-tenant environment, where a node corresponding to a tenant includes data relating to the tenant. The method may further include accepting, by the database system, a plurality of security models associated with the plurality of tenants, and configuring, based on the plurality of security models, security privileges including user privileges to be assigned to the plurality of users representing the plurality of tenants.

While the present invention is described with reference to an embodiment in which techniques for facilitating management of data in an on-demand services environment are implemented in a system having an application server providing a front end for an on-demand database service capable of supporting multiple tenants, the present invention is not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### DETAILED DESCRIPTION

Methods and systems are provided for facilitating tenant-based customization of access and security controls in an on-demand services environment in a multi-tenant environment according to one embodiment.

Embodiments provide for a tenant-based customization of access security control of user and data privileges within a multi-tenant environment. For example and in one embodiment, each tenant may be assigned a node to serve as a dedicated instance (as opposed to a service provider's centralized instance or core, such as Salesforce® core) to allow the tenant to plug-in their own security model. The tenant may then use the security for customizing security privileges for controlling searching, viewing, manipulating, etc., of data for each user associated with the tenant. Embodiments provide for employing any number of security models through dedicated nodes and calling back to a service provider's core or routing back to the tenant-built apex page, etc.

Embodiments provide for any numbers and type of layers, such as 1) core (e.g., Salesforce® core); 2) data structure server queues (e.g., Redis™ queues (RQ)); and 3) dedicated nodes and services offered through them (e.g., superpod or super POD and edge services), etc. In one embodiment, all data relating to a tenant may be extracted using an integration user who may have the privilege of viewing all data and subsequently, an edge-mart may be created to have and hold all the extracted data. This data may then be used to provide customized results to queries placed by various users of the tenant by injecting predicates, such as OwerId=$USERID, etc. For example, upon receiving and running a query in the dedicated node, the dedicated node may call the core and supplies the UserSessionId and based on which, the core may replace any previous predicate templates with the correct values and respond back to the dedicated node with the appropriate data. The dedicated node may further filter the received data, per security privileges, before providing to the user.

It is contemplated that embodiments and their implementations are not merely limited to multi-tenant database system (“MTDBS”) and can be used in other environment, such as a client-server system, a mobile device, a personal computer (“PC”), a web services environment, etc. However, for the sake of brevity and clarity, throughout this document, embodiments are described with respect to a multi-tenant database system, such as Salesforce.com®, which is to be regarded as an example of an on-demand services environment. Other on-demand services environments include Salesforce® Exact Target Marketing Cloud™.

As used herein, a term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Embodiments are described with reference to an embodiment in which techniques for facilitating management of data in an on-demand services environment are implemented in a system having an application server providing a front end for an on-demand database service capable of supporting multiple tenants, embodiments are not limited to multi-tenant databases nor deployment on application servers. Embodiments may be practiced using other database architectures, i.e., ORACLE®, DB2® by IBM and the like without departing from the scope of the embodiments claimed.

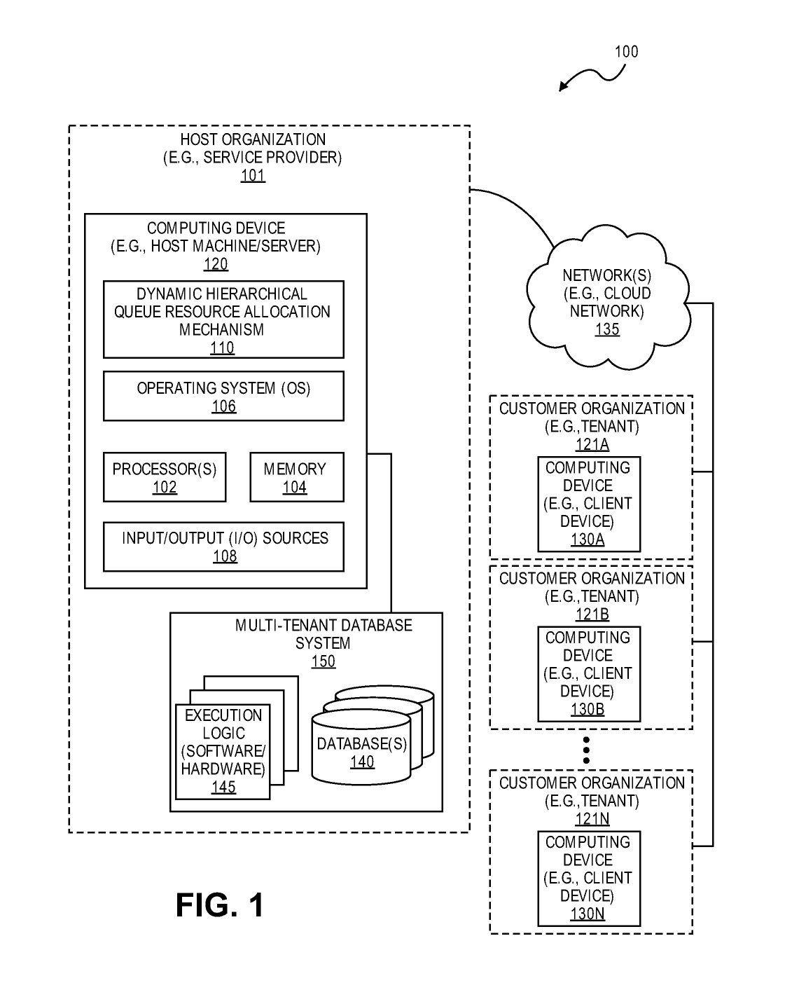

FIG. 1 illustrates a system 100 having a computing device 120 employing a dynamic access and security control mechanism 110 according to one embodiment. In one embodiment, computing device 120 includes a host server computer serving a host machine for employing dynamic access and security control mechanism (“control mechanism”) 110 for facilitating customization of access and security control in a multi-tiered, multi-tenant, on-demand services environment.

It is to be noted that terms like “queue message”, “job”, “query”, “request” or simply “message” may be referenced interchangeably and similarly, terms like “job types”, “message types”, “query type”, and “request type” may be referenced interchangeably throughout this document. It is to be further noted that messages may be associated with one or more message types which may relate to or be associated with one or more customer organizations, such as customer organizations 121A-121N, where, as aforementioned, throughout this document, “customer organizations” may be referred to as “tenants”, “customers”, or simply “organizations”. An organization, for example, may include or refer to (without limitation) a business (e.g., small business, big business, etc.), a company, a corporation, a non-profit entity, an institution (e.g., educational institution), an agency (e.g., government agency), etc.), etc., serving as a customer or client of host organization 101 (also referred to as “service provider” or simply “host”) (e.g., Salesforce®) serving as a host of control mechanism 110.

Similarly, the term “user” may refer to a system user, such as (without limitation) a software/application developer, a system administrator, a database administrator, an information technology professional, a program manager, product manager, etc. The term “user” may further refer to an end-user, such as (without limitation) one or more of customer organizations 121A-N and/or their representatives (e.g., individuals or groups working on behalf of one or more of customer organizations 121A-N), such as a salesperson, a sales manager, a product manager, an accountant, a director, an owner, a president, a system administrator, a computer programmer, an information technology (“IT”) representative, etc.

Computing device 100 may include (without limitation) server computers (e.g., cloud server computers, etc.), desktop computers, cluster-based computers, set-top boxes (e.g., Internet-based cable television set-top boxes, etc.), etc. Computing device 100 includes an operating system (“OS”) 106 serving as an interface between one or more hardware/physical resources of computing device 100 and one or more client devices 130A-130N, etc. Computing device 100 further includes processor(s) 102, memory 104, input/output (“I/O”) sources 108, such as touchscreens, touch panels, touch pads, virtual or regular keyboards, virtual or regular mice, etc.

In one embodiment, host organization 101 may further employ a production environment that is communicably interfaced with client devices 130A-N through host organization 101. Client devices 130A-N may include (without limitation) customer organization-based server computers, desktop computers, laptop computers, mobile computing devices, such as smartphones, tablet computers, personal digital assistants, e-readers, media Internet devices, smart televisions, television platforms, wearable devices (e.g., glasses, watches, bracelets, smartcards, jewelry, clothing items, etc.), media players, global positioning system-based navigation systems, cable setup boxes, etc.

In one embodiment, the illustrated multi-tenant database system 150 includes database(s) 140 to store (without limitation) information, relational tables, datasets, and underlying database records having tenant and user data therein on behalf of customer organizations 121A-N (e.g., tenants of multi-tenant database system 150 or their affiliated users). In alternative embodiments, a client-server computing architecture may be utilized in place of multi-tenant database system 150, or alternatively, a computing grid, or a pool of work servers, or some combination of hosted computing architectures may be utilized to carry out the computational workload and processing that is expected of host organization 101.

The illustrated multi-tenant database system 150 is shown to include one or more of underlying hardware, software, and logic elements 145 that implement, for example, database functionality and a code execution environment within host organization 101. In accordance with one embodiment, multi-tenant database system 150 further implements databases 140 to service database queries and other data interactions with the databases 140. In one embodiment, hardware, software, and logic elements 145 of multi-tenant database system 130 and its other elements, such as a distributed file store, a query interface, etc., may be separate and distinct from customer organizations (121A-121N) which utilize the services provided by host organization 101 by communicably interfacing with host organization 101 via network(s) 135 (e.g., cloud network, the Internet, etc.). In such a way, host organization 101 may implement on-demand services, on-demand database services, cloud computing services, etc., to subscribing customer organizations 121A-121N.

In some embodiments, host organization 101 receives input and other requests from a plurality of customer organizations 121A-N over one or more networks 135; for example, incoming search queries, database queries, application programming interface (“API”) requests, interactions with displayed graphical user interfaces and displays at client devices 130A-N, or other inputs may be received from customer organizations 121A-N to be processed against multi-tenant database system 150 as queries via a query interface and stored at a distributed file store, pursuant to which results are then returned to an originator or requestor, such as a user of client devices 130A-N at any of customer organizations 121A-N.

As aforementioned, in one embodiment, each customer organization 121A-N is an entity selected from a group consisting of a separate and distinct remote organization, an organizational group within host organization 101, a business partner of host organization 101, a customer organization 121A-N that subscribes to cloud computing services provided by host organization 101, etc.

In one embodiment, requests are received at, or submitted to, a web server within host organization 101. Host organization 101 may receive a variety of requests for processing by host organization 101 and its multi-tenant database system 150. For example, incoming requests received at the web server may specify which services from host organization 101 are to be provided, such as query requests, search request, status requests, database transactions, graphical user interface requests and interactions, processing requests to retrieve, update, or store data on behalf of one of customer organizations 121A-N, code execution requests, and so forth. Further, the web-server at host organization 101 may be responsible for receiving requests from various customer organizations 121A-N via network(s) 135 on behalf of the query interface and for providing a web-based interface or other graphical displays to one or more end-user client devices 130A-N or machines originating such data requests.

Further, host organization 101 may implement a request interface via the web server or as a stand-alone interface to receive requests packets or other requests from the client devices 130A-N. The request interface may further support the return of response packets or other replies and responses in an outgoing direction from host organization 101 to one or more client devices 130A-N.

It is to be noted that any references to software codes, data and/or metadata (e.g., Customer Relationship Model (“CRM”) data and/or metadata, etc.), tables (e.g., custom object table, unified index tables, description tables, etc.), computing devices (e.g., server computers, desktop computers, mobile computers, such as tablet computers, smartphones, etc.), software development languages, applications, and/or development tools or kits (e.g., Force.com®, Force.com Apexcode™, JavaScript™, jQuery™, Developerforce™, Visualforce™, Service Cloud Console Integration Toolkit™ (“Integration Toolkit” or “Toolkit”), Platform on a Service™ (“PaaS”), Chatter® Groups, Sprint Planner®, MS Project®, etc.), domains (e.g., Google®, Facebook®, LinkedIn®, Skype®, etc.), etc., discussed in this document are merely used as examples for brevity, clarity, and ease of understanding and that embodiments are not limited to any particular number or type of data, metadata, tables, computing devices, techniques, programming languages, software applications, software development tools/kits, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, “multi-tenant on-demand data system”, and the like, may be used interchangeably throughout this document. It is to be further noted that terms like “code”, “software code”, “application”, “software application”, “program”, “software program”, “package”, “software code”, “code”, and “software package” may be used interchangeably throughout this document. Moreover, terms like “job”, “input”, “request”, and “message” may be used interchangeably throughout this document.

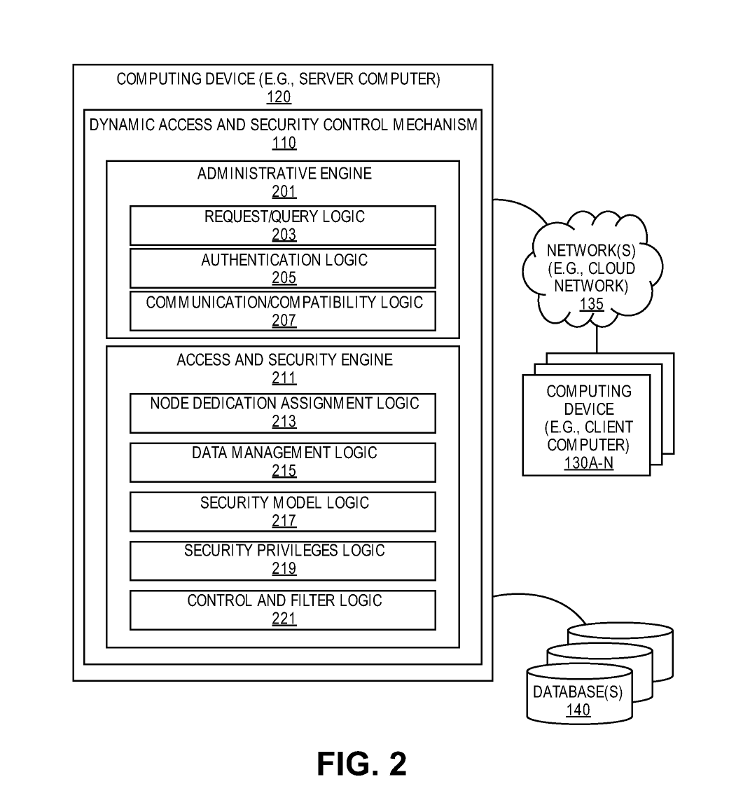

FIG. 2 illustrates a dynamic access and security control mechanism 110 according to one embodiment. In one embodiment, control mechanism 110 may include any number and type of components, such as administration engine 201 having request/query logic 203, authentication logic 205, and communication/compatibility logic 207. Similarly, control mechanism 110 may further include access and security engine 211 including node dedication and assignment logic (“node logic”) 213; data management logic 215; security model logic 217; security privileges logic 219; and control and filter logic 221.

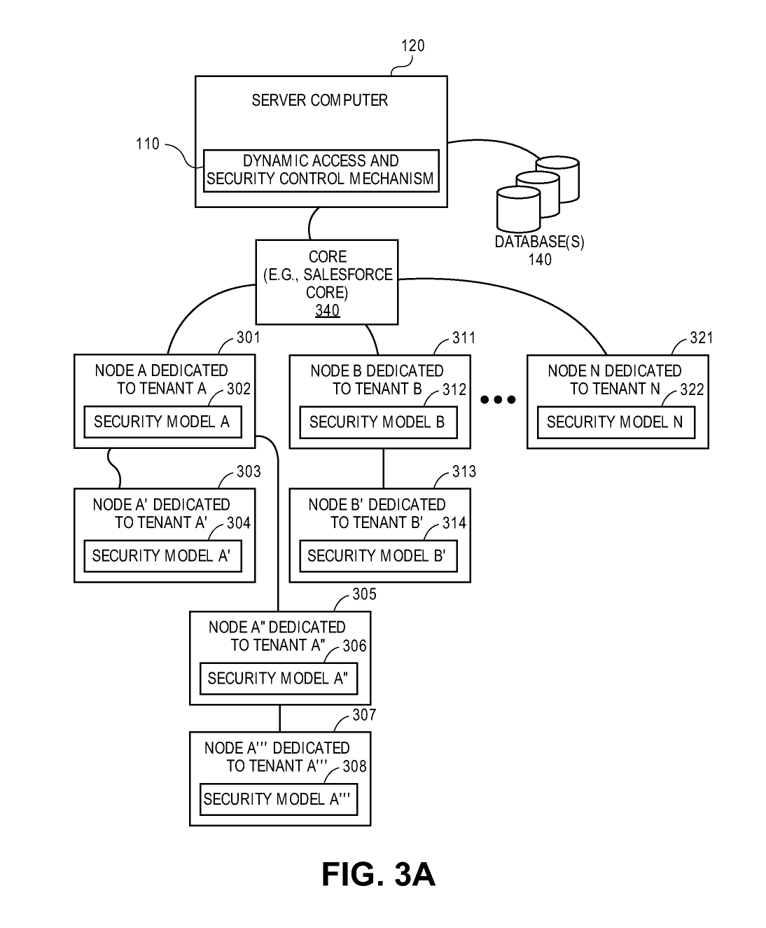

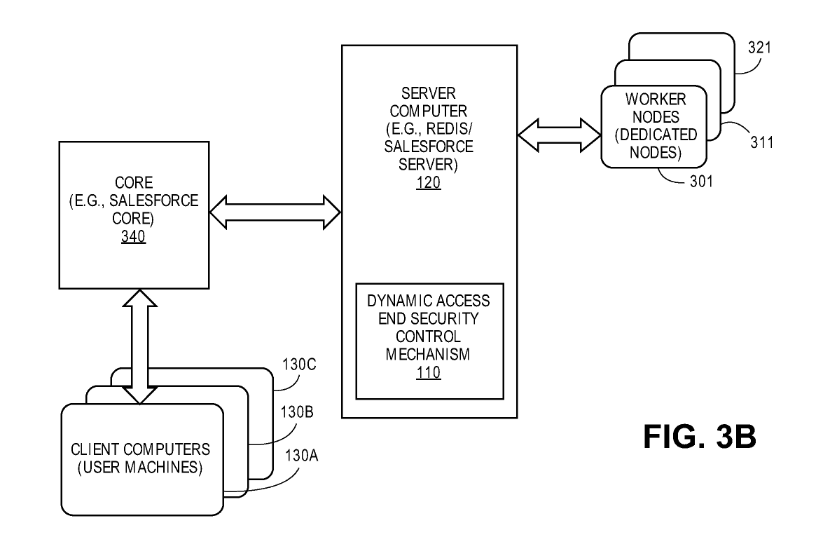

In one embodiment, computing device 120 may serve as a service provider core (e.g., Salesforce® core) for hosting and maintaining control mechanism 110 and be in communication with one or more database(s) 140, one or more client computers 130A-N, over one or more network(s) 135, and any number and type of dedicated nodes as will be further described with reference to FIG. 3.

Throughout this document, terms like “framework”, “mechanism”, “engine”, “logic”, “component”, “module”, “tool”, and “builder” may be referenced interchangeably and include, by way of example, software, hardware, and/or any combination of software and hardware, such as firmware. Further, any use of a particular brand, word, or term, such as “access control” or “security privileges”, “node”, “pod” or “Superpod”, “OwnerID” or “UserSessionID”, etc., should not be read to limit embodiments to software or devices that carry that label in products or in literature external to this document.

As aforementioned, with respect to FIG. 1, any number and type of requests and/or queries may be received at or submitted to request/query logic 203 for processing. For example, incoming requests may specify which services from computing device 120 are to be provided, such as query requests, search request, status requests, database transactions, graphical user interface requests and interactions, processing requests to retrieve, update, or store data, etc., on behalf of one or more client devices 130A-N, code execution requests, and so forth.

In one embodiment, computing device 120 may implement request/query logic 203 to serve as a request/query interface via a web server or as a stand-alone interface to receive requests packets or other requests from the client devices 130A-N. The request interface may further support the return of response packets or other replies and responses in an outgoing direction from computing device 120 to one or more client devices 130A-N.

Similarly, request/query logic 203 may serve as a query interface to provide additional functionalities to pass queries from, for example, a web service into the multi-tenant database system for execution against database(s) 140 and retrieval of customer data and stored records without the involvement of the multi-tenant database system or for processing search queries via the multi-tenant database system, as well as for the retrieval and processing of data maintained by other available data stores of the host organization's production environment. Further, authentication logic 205 may operate on behalf of the host organization, via computing device 120, to verify, authenticate, and authorize, user credentials associated with users attempting to gain access to the host organization via one or more client devices 130A-N.

In one embodiment, computing device 120 may include a server computer which may be further in communication with one or more databases or storage repositories, such as database(s) 140, which may be located locally or remotely over one or more networks, such as network(s) 235 (e.g., cloud network, Internet, proximity network, intranet, Internet of Things (“IoT”), Cloud of Things (“CoT”), etc.). Computing device 100 is further shown to be in communication with any number and type of other computing devices, such as client computing devices 130A-N, over one or more networks, such as network(s) 140.

In one embodiment, access and security engine 211 includes node logic 213 to provide for dedication and assignment to nodes to tenants in a multi-tenant environment. In one embodiment, node logic 213 may be used to generate nodes or servers to serve as instances which may be individually assigned or dedicated to the tenants in the multi-tenant environment. For example and in one embodiment, using node logic 213, a node may be generated and assigned to each tenant such that the node is and remains dedicated to that particular tenant and further used for providing data as well as accepting a security model associated with the tenant for facilitating customized access and security controls for the tenant.

It is contemplated that a tenant is not limited to a single node and that a single tenant may have multiple dedicated nodes. For example, a large organization, such as a large corporation, having multiple departments (e.g., accounting, marketing, legal, etc.), multiple layers of authority (e.g., C-level positions, directors, managers, receptionists, etc.), multiple types of businesses or sub-organizations (e.g., sodas, snacks, restaurants, sponsorships, charitable foundation, etc.) and/or the like, may need and have multiple nodes dedicated to it, such as a node may be dedicated to each department or business within an organization, etc.

In one embodiment, upon having a dedicated node, using data management logic 215, all data relating to the corresponding tenant and its associated users may be navigated, manipulated, and managed through the dedicated node to be provided to the users (e.g., employees) associated with the tenant in accordance with their corresponding security privileges. For example and in one embodiment, all data relating to a tenant may be obtained from the service provider core and managed through the dedicated node associated with the tenant, such as providing filtered data to one or more users based on their security clearance or titles within the organization. Further, these dedicated nodes may be supported by the service provider core and provide certain services that are compatible and consistent with the various services provided by the service provider (e.g., Salesforce®) and its service protocols, existing pods, public-Cloud, and multi-tenant model, etc.

In one embodiment, having data management logic 215 managing all tenant data through their dedicated nodes provides for an ability to accept and employ separate security models associated with the tenants as facilitated by security model logic 215. For example, in conventional techniques, the core may limit the tenants to only those security parameters that are exclusively offered by the core, where the tenants are bound by those security parameters and may not modify them according to their changing needs or requirements. In one embodiment, using security model logic 215, dedicated nodes are configured to accept varying security models associated with different tenants, allowing each tenant to plug-in its own security model through the dedicated node to gain the ability to set its own security parameters and preferences for its users and data. This, in one embodiment, may be achieved by routing any queries and the relevant data through the dedicated nodes and the service provider core or, in another embodiment, by allowing call backs to be routed to the various tenants' own customer-built apex pages as supported and facilitated by the dedicated nodes. Similarly, in one embodiment, any number and type security models, such as and including those allowed by Salesforce® core, may be implemented as plugins to allow for the aforementioned call backs to be routed to customer-built apex pages, etc.

In one embodiment, once a tenant has plugged-in its own security model, the tenant may then be authorized to set and modify its own security privileges based on its own security preferences, as desired or necessitated, and as facilitated by security privileges logic 219. For example, the tenant may determine that the security privileges may be assigned based on one or more of a user′ position or data clearance within the organization, data sensitivity (employee personal data, confidential projects, etc.), unfolding events (e.g., pending lawsuits, pending acquisition, etc.), department rules, etc. For example, a vice president (VP) of marketing in marketing department may, by virtue of his position, have access to more and/or different data (e.g., tables, fields, reports, columns, rows, etc.) than a sales associate in his department. In one embodiment, having a personalized security model through a dedicated node allows for each tenant to have its own customized security protocols and preferences as facilitated by security privileges logic 219.

Once the security privileges have been established through the security model as facilitated by security privileges logic 219, control and filter logic 221 may then be used to ensure that the established security privileges are enforced. For example, using the aforementioned example, control and filter logic 221 may control and filter certain information (e.g., rows, columns of information in data) from the data in accordance with the security privileges, such as, continuing with the above example, VP of marketing may be receive and view sales data for all sales associates but a sales associated may only see the data for his/her own sales (rows and/or columns of other data may be filtered out using control and filter logic 221).

As aforementioned, multiple nodes corresponding to multiple tenants may be in communication with and routed through the service provider core. In one embodiment, a digestion process, as facilitated by security privileges logic 219 and control and filter logic 221, may be used to offer an ability to inject predicates, such as OwnerId=$USERID, etc., into the security model supported by the dedicated node. These predicates may then be used to obtain data (such as through the service provider core) and provide the selected or filtered data (such as to various users) as facilitated by control and filter logic 221. For example, in receiving and running a user query on a dedicated node (such as Salesforce® Superpod™), the dedicated node may call on the service provider core (e.g., Salesforce® core) and supply a predicate, such as UserSessionId, etc., to obtain the relevant data from a data source through the core. In response, the core having knowledge of and based on UserSessionId, replaces any other predicate template with the right value and accordingly, responds back to the dedicated node with the relevant data. The dedicated node may get the get the relevant data with the expanded predicate and apply any control or filters, using control and filter logic 221, to achieve the restricted data access in response to the query placed by a user associated with the tenant.

In one embodiment, a dedicated instance may know that the data that is to be filtered out in order to restrict access to the filtered-out data without knowing or having sufficient information about one or more users seeking data. Further, for example and in one embodiment, an “edge-mart” may be created and associated with each tenant and its dedicated node to be used to provide edge-mart services, such as having all the data relating to a tenant which may have been extracted through the core using an “integration user” having “view all data” privilege.

In one embodiment, user queries may be communicated using queues, such as RQ which may refer to a Python library for queuing jobs/requests and processing them in the background with workers or worker nodes. RQ may be designed to have low barrier for entry and easy integration in web stack. In one embodiment, a dedicated node may include an instance or a node, such as an application server, in a multi-tenant cloud, running on an infrastructure, to provide the aforementioned services to a tenant including a large enterprise organization and its employees and customers.

Communication/compatibility logic 207 may facilitate the ability to dynamically communicate and stay configured with any number and type of software/application developing tools, models, data processing servers, database platforms and architectures, programming languages and their corresponding platforms, etc., while ensuring compatibility with changing technologies, parameters, protocols, standards, etc.

It is contemplated that any number and type of components may be added to and/or removed from control mechanism 110 to facilitate various embodiments including adding, removing, and/or enhancing certain features. It is contemplated that embodiments are not limited to any particular technology, topology, system, architecture, and/or standard and are dynamic enough to adopt and adapt to any future changes.

FIG. 3A illustrates an architectural setup 300 as facilitated and supported by control mechanism 110 of FIG. 2 according to one embodiment. As an initial matter, various processes and component discussed above with reference to FIGS. 1-2 are not discussed or repeated hereafter. Further, it is contemplated and to be noted that architectural setup 300 merely discloses an overly simplified setup for brevity, clarity, and ease of understanding and that embodiments are not limited as such.

As illustrated, in one embodiment, setup 300 may include server computer 120, as supported and provided a service provider (Salesforce®) serving to host control mechanism 110 which may be in communication with a service provider core 340 (e.g., Salesforce® core) serving as a core instance/node associated with the service provide. For example, in some embodiments, server computer 120 may include a particular server computer, such as a Redis™ server, that is supported and provided by the service provider, such as Salesforce®. In one embodiment and as aforementioned with respect to FIG. 2, using control mechanism 110, any number and type of worker nodes (e.g., server sub-systems/devices) may be configured to serve as dedicated to nodes 301, 303, 305, 307, 311, 313, and 321 to their respective tenants A, A′, A″, A′″, B, B′, and N corresponding to tenants A 121A, B 121B, and N 121N of FIG. 1.

It is further illustrated that server computer 120 may be in communication with database(s) 140 that stores and maintains any amount and type of data and metadata that may be extracted for and by dedicated nodes 301, 303, 305, 307, 311, 313, and 321 to then be used in response to data queries, etc., placed by, for example, users associated with their corresponding tenants, such as tenants A 121A, B 121B, and N 121N of FIG. 1. In some embodiments, database(s) 140 may be directly in communication with core 340.

As aforementioned with respect to FIG. 2, each tenant, such as tenant A, B, and N, may be facilitated a dedicated node A 301, B 311, and N 321, but in some embodiments, a single tenant be assigned multiple nodes based on any number and type of factors, such as authority levels, department differences, varying businesses, etc. For example, tenant A may be assigned nodes A′ 303, A″ 305, and A′″ 307 for additional access and security control purposes which may be further customized and personalized based on one or more of the aforementioned factors. For example, tenant A (e.g., PepsiCo® may be an organization (e.g., corporation, business, etc.) involved in multiple businesses, such as selling soda (e.g., Pepsi®, Mountain Dew®, etc.) and running restaurants (e.g., Kentucky Fried Chicken®, Pizza Hut®, Taco Bell®, etc.), etc., and accordingly, tenant A being the parent organization is associated with node A 301 and its various businesses being child organizations may also be associated with their own corresponding nodes, such as a first child organization dealing with the soda business side of tenant A may be referenced as tenant A′ and assigned node A′ 303, and similarly, a second child organization dealing with the restaurant business side of tenant A may be referenced as tenant A″ and assigned node A″ 305. It is further contemplated that a child organization, such as tenant A″ (e.g., restaurant business), may serve as both child and parent and thus, include a child organization of its own, such as tenant A′″ which, for example, refers to a specific restaurant chain, such as Pizza Hut®, and is assigned its own dedicated node, such as node A′″ 307.

Further, in one embodiment, each dedicated node may be configured to accept a separate security model corresponding to a tenant, such as nodes 301, 303, 305, 307, 311, 313, and 321 are shown to have accepted security models 302, 304, 306, 308, 312, 314, and 322 corresponding to their tenants A, A′, A″, A′″, B, B′, and N. Each tenant, such as tenant A 121A, B 121B, and N 121N of FIG. 1 and their child organizations/tenants A′, A″, A′″, and B′ may be able to employ their own user and/or data security privileges based on their security preferences as provided through nodes 301, 303, 305, 307, 311, 313, and 321 and facilitated by control mechanism 110.

FIG. 3B illustrates another architectural setup 350 as facilitated and supported by control mechanism 110 of FIG. 2 according to one embodiment. As aforementioned, various processes and component discussed above with reference to FIGS. 1-3A are not discussed or repeated hereafter. Further, it is contemplated and to be noted that architectural setup 350 merely discloses an overly simplified setup for brevity, clarity, and ease of understanding and that embodiments are not limited as such

As with FIG. 3A, server computer 120 hosting control mechanism 110 may be in communication with core (e.g., Salesforce® core) 340 and worker nodes 301, 311, 321 serving as dedicated nodes, where core 340 is further in communication with client computers 130A, 130B, 130C serving as user machines. For example, in some embodiments, server computer 120 may include a particular server computer, such as a Redis™ server, that is supported and provided by the service provider, such as Salesforce®

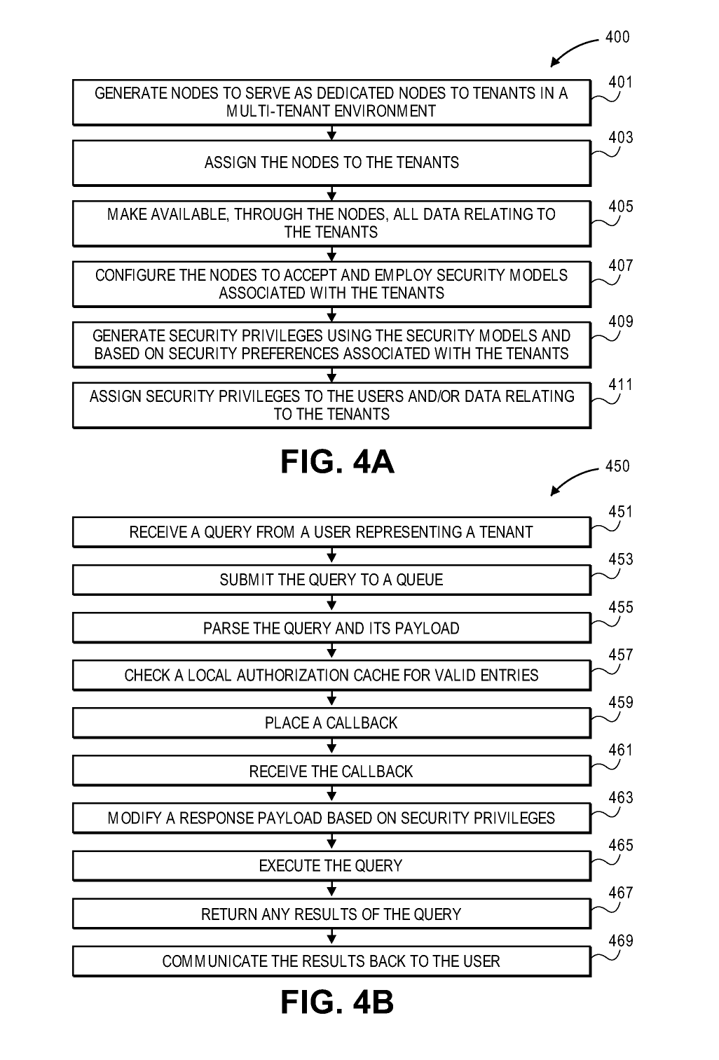

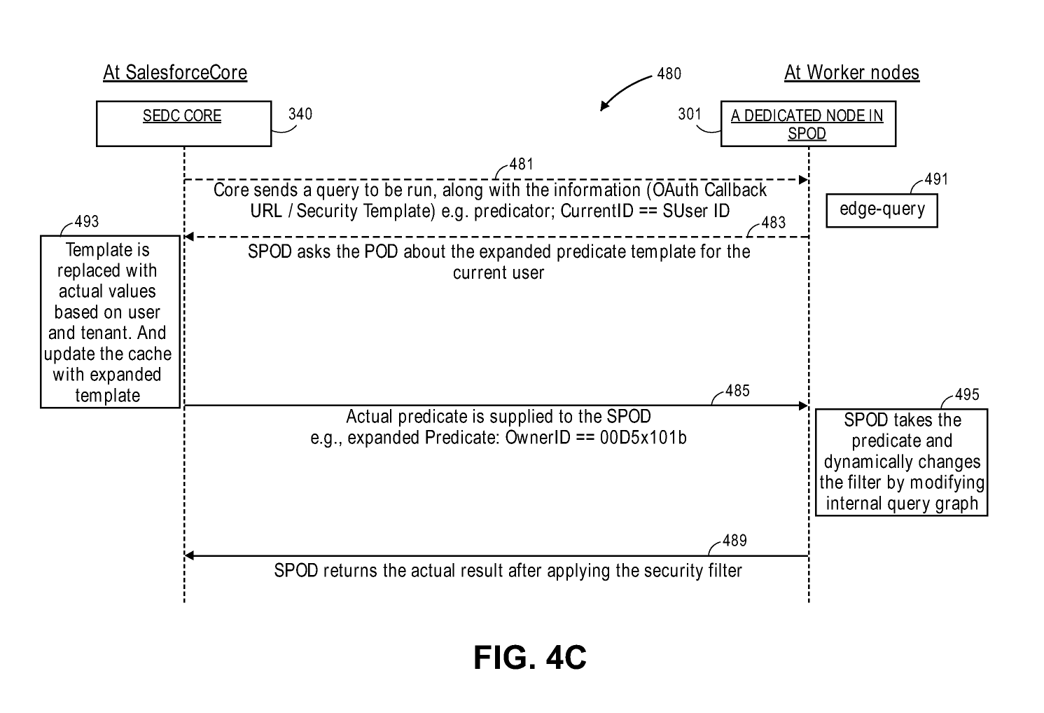

FIG. 4A illustrates a method 400 for facilitating dynamic access and security controls according to one embodiment. Method 400 may be performed by processing logic that may comprise hardware (e.g., circuitry, dedicated logic, programmable logic, etc.), software (such as instructions run on a processing device), or a combination thereof. In one embodiment, method 400 may be performed or facilitated by one or more components of control mechanism 110 of FIG. 2. The processes of method 400 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-3B may not be repeated or discussed hereafter.

Method 400 starts with block 401 with generating nodes/instances to serve as dedicated nodes for tenants in a multi-tenant environment. Each node may be in and remain in communication with a service provider core, one or more database, etc. At block 403, the nodes are then assigned to tenants such that each node serves as a dedicated node to its corresponding tenant. As aforementioned and illustrated with reference to FIG. 3, in one embodiment, a tenant is not limited to having assigned a single node and that any number of nodes may be dedicated to the tenant. At block 405, using the core and the one or more databases, all data and metadata relating to the tenants is associated with or made accessible through their corresponding dedicated nodes such that each tenant's data is readily available at or accessible through its corresponding dedicated node.

At block 407, in one embodiment, the dedicated nodes are intelligently configured to accept and employ security models associated with the tenant such that each node is configured to accept and employ a security model associated with its corresponding tenant. At block 409, security privileges (such as user privileges, data privileges, etc.) may be generated based on the tenants' security preferences and using their corresponding security models. At block 411, users and/or data associated with the tenants are assigned security privileges such that each user and/or piece of data may be access and security controlled through the assigned security privileges that are based on the corresponding tenant's security preferences and protocols, such as a VP marketing may receive more data than a sales associate, a legal counsel may have access to certain aspects of a confidential matter than a legal secretary, etc.

FIG. 4B illustrates a transaction sequence 450 representing a query path according to one embodiment. Transaction sequence 450 may be performed by processing logic that may comprise hardware (e.g., circuitry, dedicated logic, programmable logic, etc.), software (such as instructions run on a processing device), or a combination thereof. In one embodiment, transaction sequence 450 may be performed or facilitated by one or more components of control mechanism 110 of FIG. 2. The processes of transaction sequence 450 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-4A may not be repeated or discussed hereafter.

Transaction sequence 450 representing a query path that begins at block 451 with receiving a user query (e.g., edge-mart query) from a user representing a tenant (e.g., organization, such as a business, etc.), where the user query may be placed using a client computing device (e.g., client computer, such as client device 130A, 130B, 130N) associated with the tenant. The user query may be placed by the user to obtain a set of data, where the query may be received, over a network (e.g., cloud network, the Internet), at request/query logic 203 and then authenticated using authentication logic 205 of FIG. 1. At block 453, a service provider core submits the query to a queue (e.g., RQ), where the service provider core may perform one or more of adding a callback Uniform Resource Locator (URL) to the query parameters, creating a child session and appending a session identification (SID) to the query, and retiring a container whitelist as a payload parameter, etc.

At block 455, at a dedicated node corresponding to the tenant, using one or more components of control mechanism 110, such as request/query logic 203, of FIG. 1, the query and its corresponding payload are parsed. At block 457, at the dedicated node, a local authorization cache, such as at database(s) 140 of FIG. 2, may be checked for valid entries (e.g., if all present and valid, go to inject), etc., and, at block 459, a callback, using the URL provided in the payload, is made from the dedicated node to the service provider core. At block 461, the callback is received at the core and the core then performs one or more of checking user access permission, looking up, if user has access, one or more predicate templates for each requested edge-mart/version, and dereferencing the one or more predicate templates to a predicate strings which are then passed back to the dedicated node in a response payload.

At block 463, at the dedicated node, the response payload may be appropriately altered based on any relevant security privileges, using control and filter logic 221 of FIG. 2, such as parsing the predicate strings and injecting the resulting filter, etc. At block 465, the query is executed and, at block 467, upon execution of the query, any results, including data, obtained in response to the query are then returned back to the service provider core. At block 469, the service provider core then communicates, over the network, the results back to the user at the client computing device associated with the tenant and accessible by the user.

FIG. 4C illustrates a transaction sequence 480 representing a communication between core 340 and dedicated node 301 according to one embodiment. Transaction sequence 480 may be performed by processing logic that may comprise hardware (e.g., circuitry, dedicated logic, programmable logic, etc.), software (such as instructions run on a processing device), or a combination thereof. In one embodiment, transaction sequence 480 may be performed or facilitated by one or more components of control mechanism 110 of FIG. 2. The processes of transaction sequence 480 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-4B may not be repeated or discussed hereafter.

In one embodiment, transaction sequence 480 begins with a query 491 (e.g., edge query 340) with core 340 sending the query to be run along with any relevant information (e.g., OAuth Callback URL, security template, such as predicate OwnerID=$User.ID, etc.) at 481, wherein dedicated node 301 responds with asking core 340 about expanded predicate template for the current user at 483. For example, at 493, the template may be replaced with actual values based on user and tenant and update the cache with expanded template. In one embodiment, core 340 supplies an actual predicate (e.g., expanded predicate, such as OwnerID=00D5xf01b) to node 301 at 485. At 495, node 301 takes the predicate and dynamically changes the filter by modifying internal query graph. At 489, node 301 returns the actual result after applying the security filter.

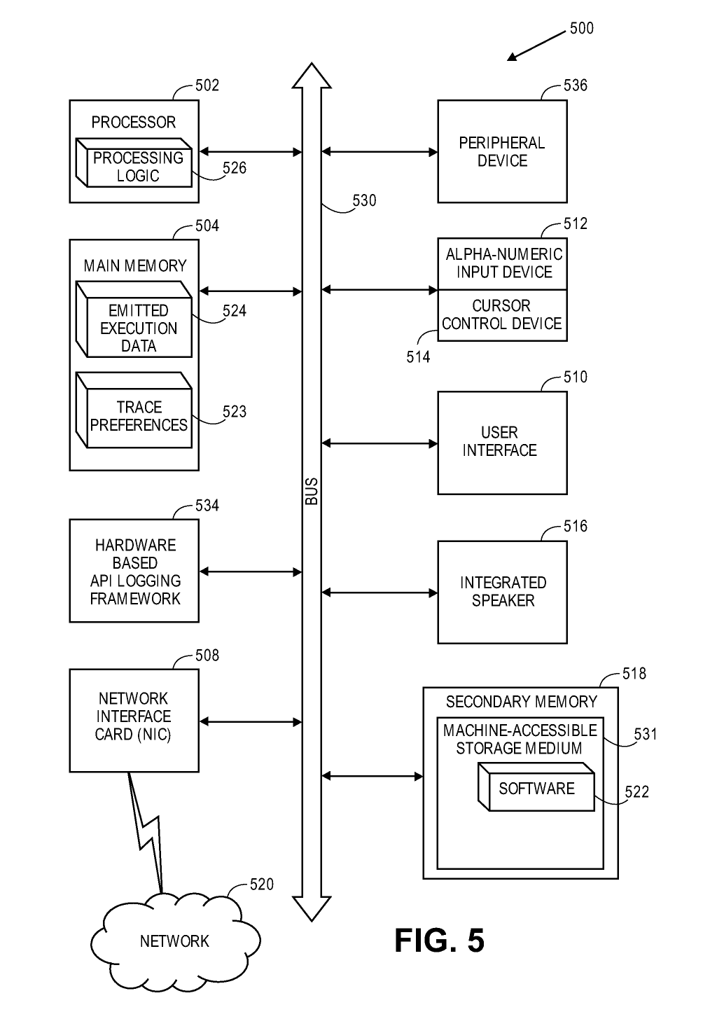

FIG. 5 illustrates a diagrammatic representation of a machine 500 in the exemplary form of a computer system, in accordance with one embodiment, within which a set of instructions, for causing the machine 500 to perform any one or more of the methodologies discussed herein, may be executed. Machine 500 is the same as or similar to computing devices 120, 130A-N of FIG. 1. In alternative embodiments, the machine may be connected (e.g., networked) to other machines in a network (such as host machine 120 connected with client machines 130A-N over network(s) 135 of FIG. 1), such as a cloud-based network, Internet of Things (IoT) or Cloud of Things (CoT), a Local Area Network (LAN), a Wide Area Network (WAN), a Metropolitan Area Network (MAN), a Personal Area Network (PAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processor 502, a main memory 504 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 518 (e.g., a persistent storage device including hard disk drives and persistent multi-tenant data base implementations), which communicate with each other via a bus 530. Main memory 504 includes emitted execution data 524 (e.g., data emitted by a logging framework) and one or more trace preferences 523 which operate in conjunction with processing logic 526 and processor 502 to perform the methodologies discussed herein.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute the processing logic 526 for performing the operations and functionality of control mechanism 110 as described with reference to FIG. 1 other figures discussed herein.

The computer system 500 may further include a network interface card 508. The computer system 500 also may include a user interface 510 (such as a video display unit, a liquid crystal display (LCD), or a cathode ray tube (CRT)), an alphanumeric input device 512 (e.g., a keyboard), a cursor control device 514 (e.g., a mouse), and a signal generation device 516 (e.g., an integrated speaker). The computer system 500 may further include peripheral device 536 (e.g., wireless or wired communication devices, memory devices, storage devices, audio processing devices, video processing devices, etc. The computer system 500 may further include a Hardware based API logging framework 534 capable of executing incoming requests for services and emitting execution data responsive to the fulfillment of such incoming requests.

The secondary memory 518 may include a machine-readable storage medium (or more specifically a machine-accessible storage medium) 531 on which is stored one or more sets of instructions (e.g., software 522) embodying any one or more of the methodologies or functions of control mechanism 110 as described with reference to FIG. 1, respectively, and other figures discussed herein. The software 522 may also reside, completely or at least partially, within the main memory 504 and/or within the processor 502 during execution thereof by the computer system 500, the main memory 504 and the processor 502 also constituting machine-readable storage media. The software 522 may further be transmitted or received over a network 520 via the network interface card 508. The machine-readable storage medium 531 may include transitory or non-transitory machine-readable storage media.

Portions of various embodiments may be provided as a computer program product, which may include a computer-readable medium having stored thereon computer program instructions, which may be used to program a computer (or other electronic devices) to perform a process according to the embodiments. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment may be implemented using different combinations of software, firmware, and/or hardware.

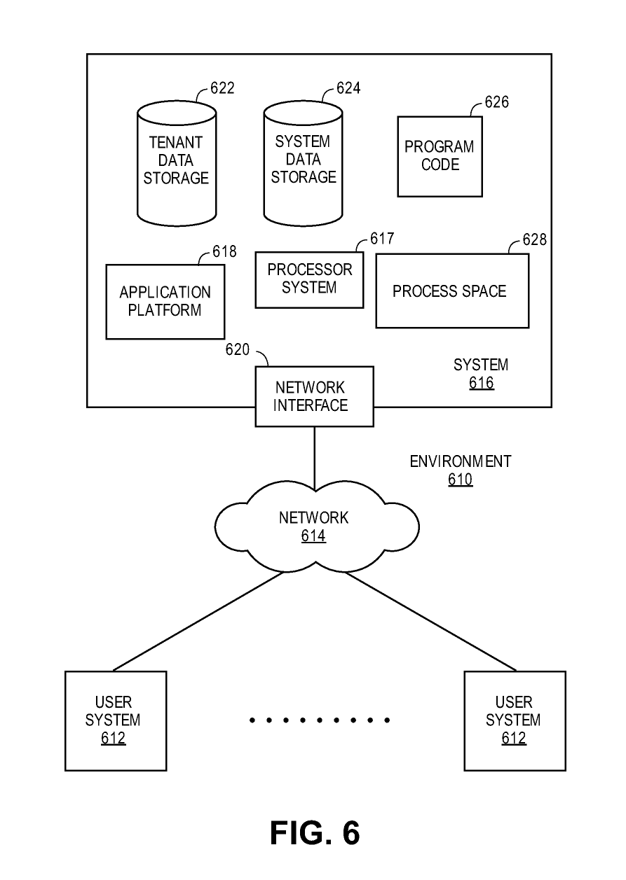

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

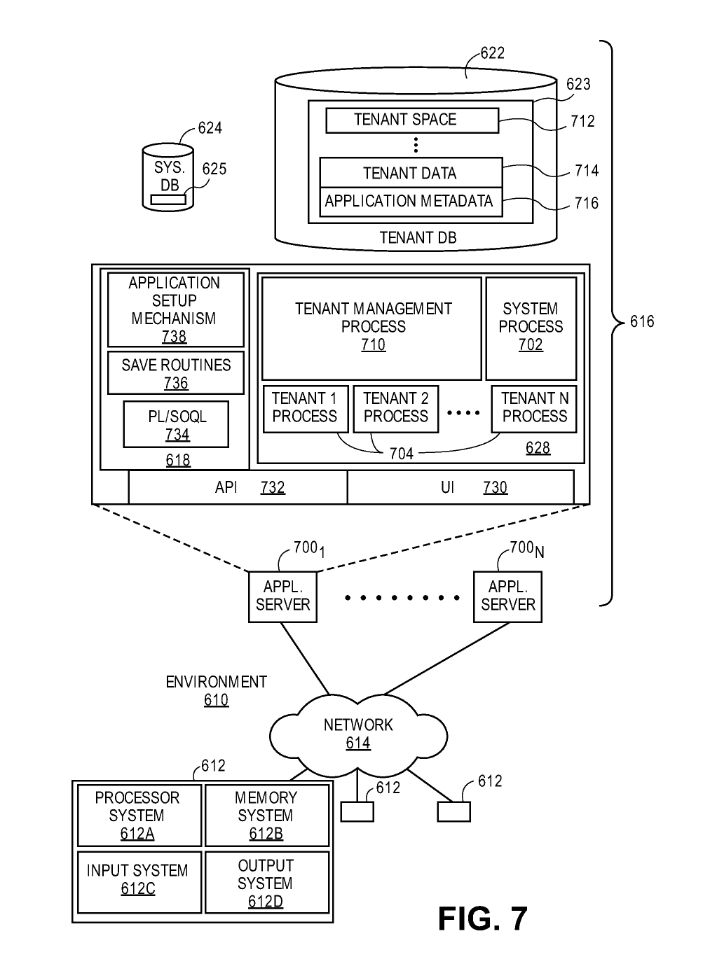

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in herein FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. User system 612 further includes Mobile OS (e.g., iOS® by Apple®, Android®, WebOS® by Palm®, etc.). Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Core® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™ JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Any of the above embodiments may be used alone or together with one another in any combination. Embodiments encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. A database system-implemented method comprising:
generating, by the database system, a plurality of nodes corresponding to a plurality of tenants in a multi-tenant environment, wherein a node corresponding to a tenant includes data relating to the tenant;
accepting, by the database system, a plurality of security models associated with the plurality of tenants; and
configuring, based on the plurality of security models, security privileges including user privileges to be assigned to the plurality of users representing the plurality of tenants.

2. The method of claim 1, wherein a security model accepted by a node associated with the tenant is customized in accordance with a set of security preferences of the tenant, wherein the tenant includes an organization representing a business, a not-profit entity, a government agency, and an educational institution.

3. The method of claim 2, further comprising generating the set of security preferences based on one or more factors relating to at least one of the user and the data relating to the tenant.

4. The method of claim 3, wherein the one or more factors include at least one of a position of the user within the organization, a security clearance associated with the user, sensitivity or confidential associated with one or more portions of the data, an ongoing event relating to the tenant, and availability of system resources or bandwidth.

5. The method of claim 1, wherein a set of user privileges of the user privileges is assigned to a user based on the security model associated with the tenant, wherein the security privileges further include a set of data privileges associated with the data relating to the tenant.

6. The method of claim 1, wherein the plurality of nodes are coupled to a core associated with a service provider, wherein the core to facilitate movement of data between a database and a plurality of nodes on behalf of the plurality of tenants and in response to one or more queries placed by one or more users associated with one or more tenants.

7. The method of claim 1, further comprising:
receiving a query from the user associated with the tenant, wherein the query is placed using a computing device, wherein the query request a set of data;
processing the query based on at least one of the set of user privileges and the set of data privileges, wherein processing includes modifying the set of data;
communicating results of the query back to the user at the computing device over the network, wherein the results include the modified set of data, wherein the network includes a cloud network.

8. A system comprising:
a processor and a memory to execute instructions at the system; and
a mechanism to:
generate, by the database system, a plurality of nodes corresponding to a plurality of tenants in a multi-tenant environment, wherein a node corresponding to a tenant includes data relating to the tenant;
accept, by the database system, a plurality of security models associated with the plurality of tenants; and
configure, based on the plurality of security models, security privileges including user privileges to be assigned to the plurality of users representing the plurality of tenants.

9. The system of claim 8, wherein a security model accepted by a node associated with the tenant is customized in accordance with a set of security preferences of the tenant, wherein the tenant includes an organization representing a business, a not-profit entity, a government agency, and an educational institution.

10. The system of claim 9, wherein the mechanism is further to generate the set of security preferences based on one or more factors relating to at least one of the user and the data relating to the tenant.

11. The system of claim 10, wherein the one or more factors include at least one of a position of the user within the organization, a security clearance associated with the user, sensitivity or confidential associated with one or more portions of the data, an ongoing event relating to the tenant, and availability of system resources or bandwidth.

12. The system of claim 8, wherein a set of user privileges of the user privileges is assigned to a user based on the security model associated with the tenant, wherein the security privileges further include a set of data privileges associated with the data relating to the tenant.

13. The system of claim 8, wherein the plurality of nodes are coupled to a core associated with a service provider, wherein the core to facilitate movement of data between a database and a plurality of nodes on behalf of the plurality of tenants and in response to one or more queries placed by one or more users associated with one or more tenants.

14. The system of claim 8, wherein the mechanism is further to:
receive a query from the user associated with the tenant, wherein the query is placed using a computing device, wherein the query request a set of data;
process the query based on at least one of the set of user privileges and the set of data privileges, wherein processing includes modifying the set of data;
communicate results of the query back to the user at the computing device over the network, wherein the results include the modified set of data, wherein the network includes a cloud network.

15. A machine-readable medium comprising a plurality of instructions which, when executed by a processing device, cause the processing device to perform one or more operations comprising:
generating, by the database system, a plurality of nodes corresponding to a plurality of tenants in a multi-tenant environment, wherein a node corresponding to a tenant includes data relating to the tenant;
accepting, by the database system, a plurality of security models associated with the plurality of tenants; and
configuring, based on the plurality of security models, security privileges including user privileges to be assigned to the plurality of users representing the plurality of tenants.

16. The machine-readable medium of claim 15, wherein a security model accepted by a node associated with the tenant is customized in accordance with a set of security preferences of the tenant, wherein the tenant includes an organization representing a business, a not-profit entity, a government agency, and an educational institution.

17. The machine-readable medium of claim 16, wherein the one or more operations further comprise generating the set of security preferences based on one or more factors relating to at least one of the user and the data relating to the tenant.

18. The machine-readable medium of claim 17, wherein the one or more factors include at least one of a position of the user within the organization, a security clearance associated with the user, sensitivity or confidential associated with one or more portions of the data, an ongoing event relating to the tenant, and availability of system resources or bandwidth.

19. The machine-readable medium of claim 15, wherein a set of user privileges of the user privileges is assigned to a user based on the security model associated with the tenant, wherein the security privileges further include a set of data privileges associated with the data relating to the tenant.

20. The machine-readable medium of claim 15, wherein the plurality of nodes are coupled to a core associated with a service provider, wherein the core to facilitate movement of data between a database and a plurality of nodes on behalf of the plurality of tenants and in response to one or more queries placed by one or more users associated with one or more tenants.

21. The machine-readable medium of claim 15, wherein the one or more operations further comprise:
receiving a query from the user associated with the tenant, wherein the query is placed using a computing device, wherein the query request a set of data;
processing the query based on at least one of the set of user privileges and the set of data privileges, wherein processing includes modifying the set of data;
communicating results of the query back to the user at the computing device over the network, wherein the results include the modified set of data, wherein the network includes a cloud network.
